(19) United States
(12) Patent Application Publication
(10) Pub. No.: US 2026/0307914 A1
(43) Pub. Date: Oct. 8, 2026

(54) MULTIPLE BALE RECEIVING SYSTEM FOR BALE PROCESSOR

(71) Applicant: Marcrest Manufacturing Inc., Listowel (CA)

(72) Inventor: Keith HORST, Listowel (CA)

(21) Appl. No.: 19/636,360

(22) Filed: Apr. 1, 2026

Related U.S. Application Data
(60) Provisional application No. 63/782,059, filed on Apr. 2, 2025.

(51) Int. Cl. B65G 43/10; A01F 29/10; A01F 29/12; B65G 47/88

(52) U.S. Cl. CPC B65G 43/10; A01F 29/10; A01F 29/12; B65G 47/88; B65G 2201/0202; B65G 2203/0233

(57) ABSTRACT

A system for collecting multiple bales at one end of the system and for guiding the multiple bales out of the system in a single file.

### CROSS-REFERENCE TO OTHER APPLICATIONS

The disclosure claims priority from U.S. Provisional Application No. 63/782,059 filed Apr. 2, 2025 which is hereby incorporated by reference.

### FIELD

The disclosure is generally directed at farming equipment and, more specifically, at a multiple bale receiving system for a bale processor.

### BACKGROUND

As is well known in the art, a bale of forage material (e.g., straw, grass, hay) is formed in a baler by compressing the forage material to form the forage material into a cube-like shape with predetermined dimensions which is typically referred to as a bale. Recently, multiple-bale balers have been developed with multiple chambers, or a double wide chamber with a knife to split the forage material into separate cubes, for the purpose of creating two bales simultaneously. FIG. 1 is a schematic illustration of an exit chamber 1 of a multiple-bale baler, showing bales “B₁” and “B₂” exiting therefrom.

In FIG. 1, bales “B₁” and “B₂” are shown exiting from the exit chamber 1 of the multiple-bale baler, via a left, or first, chamber exit 1A and a right, or second, chamber exit 1B thereof respectively. The bales “B₁”, “B₂” are moved in the directions indicated by arrows “A₁”, “A₂” respectively.

As is well known in the art, the exit chamber 1 may have any suitable configuration. In some embodiments, a guiding device is attached to guide the bales as they exit.

An example of a guiding device (referred to as an ejection chute structure) is disclosed in U.S. Patent Publication No. 2024/0016096, now U.S. Pat. No. 12,256,676, entitled “Baling Apparatus and Method”.

When the ejection chute structure is used, the bales are placed on the ground as the baler moves forward. The bales are subsequently picked up. Often, the bales are picked up and further processed in a bale processor, e.g., in a bale stacker, such as the bale stacker described in U.S. Pat. No. 7,610,851 which is hereby incorporated by reference. In general, conventional bale processors are configured to pick up one bale at a time off the ground.

The known guiding devices on multiple-bale balers may be configured to distribute the bales exiting therefrom in a pattern that is intended to space the bales apart laterally as well as longitudinally as the baler moves forward, so that the bales are spaced apart and the conventional bale processors can pick the bales up, one at a time. However, often the bales are deposited two at a time, positioned more or less side-by-side on the ground. Regardless of how the bales are distributed on the ground in order to pick up the bales produced from a multiple-bale baler, the conventional bale processing machine or processor is unable to pick up the bales in one pass in a straight line, but instead must turn sharply from one side to the other as it follows the baler. Alternatively, the bale processor may need to make two passes down the field in order to pick up the multiple bales.

For the foregoing reasons, the conventional bale processor cannot progress as quickly as it otherwise could, e.g., if the conventional bale processor were able to pick up all the bales in a straight line and in one pass. Also, following the winding path subjects the conventional bale processor to wear that may ultimately result in increased maintenance costs. The result is that, in the prior art, the full benefits that should result from the multiple-bale baler are not realized.

In addition, the orientation of the baler in relation to the bale processor changes, as the baler and the bale processor move over a field. When the baler is progressing straight across a field, the bale processor can follow in a winding but overall generally straight path, as described above. However, at the end of every row, the baler turns, usually sharply, toward the next row. As a result, the bales may be positioned in a somewhat irregular pattern in places, further complicating the path that the bale processor is required to follow to pick up all the bales, and further reducing efficiency.

Therefore, there is provided a novel method and system for guiding multiple bales from a baler individually into a baler processor.

### SUMMARY

For the foregoing reasons, there is a need for a system for collecting bales, and guiding the bales separately to move individually along a path, that overcomes or mitigates one or more of the defects or disadvantages of current baling apparatus.

In its broad aspect, the disclosure provides a system for collecting bales and guiding the bales separately to move individually along a path. The system includes a guidance subsystem, which includes a body extending between an upstream end, at which the bales enter the body, and a downstream end, at which the bales individually exit the body.

The guidance subsystem also includes an exit conveyor that is mounted to the body and extends between an upstream end thereof and a downstream end thereof located proximal to the downstream end of the body. The upstream end is located at an intermediate point on the body, intermediate between the upstream and downstream ends of the body.

The guidance subsystem also includes multiple, such as, but not limited to, a pair of, intake conveyors, for moving the bales in a downstream direction toward the upstream end of the exit conveyor. In the following description, the set of intake conveyors includes a pair of intake conveyors.

The system also includes a conveyor control subsystem, for selecting a first one of the pair of intake conveyors for activation to move a selected bale thereon, and selecting a second one of the pair of intake conveyors for de-activation based on predetermined criteria.

Upon activation, the first selected one of the pair of intake conveyors moves the selected bale downstream to position the selected bale on the upstream end of the exit conveyor, for the exit conveyor to move the selected bale to the downstream end.

In one aspect of the disclosure, there is provided a system for collecting multiple bales and guiding the multiple bales separately to move individually along a path, the system including a guidance subsystem including a body extending between an upstream end, at which the multiple bales enter the body, and a downstream end, at which the bales exit the body individually; an exit conveyor mounted to the body and extending between an upstream end thereof at an intermediate point on the body and a downstream end thereof located proximal to the downstream end of the body; a set of intake conveyors, for moving the bales in a downstream direction toward the upstream end of the exit conveyor; and a conveyor control subsystem, for selecting a first one of the set of intake conveyors for activation to move a selected bale thereon, and selecting a second one of the pair of intake conveyors for de-activation based on predetermined criteria, wherein upon activation, the first selected one of the pair of intake conveyors moves the selected bale downstream to position the selected bale on the upstream end of the exit conveyor, for the exit conveyor to move the selected bale to the downstream end thereof.

In another aspect of the disclosure, there is provided a system for collecting and guiding bales to a bale processor including a guidance subsystem including a body portion; an intake conveyor portion connected to one end of the body, the intake conveyor portion including at least two intake conveyors; and an exit conveyor portion connected located between the body portion and the bale processor; a conveyor control subsystem for activating one of the at least two intake conveyors in response to a signal indicating a presence of a bale within the one of the at least two intake conveyors and for deactivating each of the other of the at least two intake conveyors; wherein activation of the one of the at least two conveyors urges the bale from the intake conveyor to the exit conveyor portion to move the bale in a single file to the bale processor.

In a further aspect, the conveyor control subsystem includes a set of sensors associated with each of the at least two intake conveyors to sense a presence of a bale within its associated intake conveyor. In another aspect, the system includes a processor for receiving a bale sensing signal from one of the set of sensors and activating the intake conveyor associated with the sensor transmitting the bale sensing signals and for deactivating each of the other intake conveyors. In yet a further aspect, each of the intake conveyors includes a set of paddles for directing received bales towards the exit conveyor. In yet another aspect, the guidance subsystem further includes a guiding mechanism located between the intake conveyor portion and the exit conveyor portion to guide the bales from the intake conveyor portion to the exit conveyor. In another aspect, the guiding mechanism includes a set of entry guide panel assemblies. In yet a further aspect, each of the set of entry guide panel assemblies includes a set of guide panels. In another aspect, the guiding mechanism includes a central guide panel assembly. In an aspect, the exit conveyor portion is a belt conveyor.

### BRIEF DESCRIPTION OF THE DRAWINGS

The disclosure will be better understood with reference to the attached drawings, in which:

FIG. 1 is an isometric view of exit chambers of a prior art multiple-bale baler;

FIG. 2 is a schematic illustration of an embodiment of a system of the disclosure;

FIG. 3A is an isometric view of an embodiment of a guidance subsystem of the disclosure positioned downstream from an exit chamber;

FIG. 3B is a top view of the guidance subsystem of FIG. 3A;

FIG. 4 is a top view of the guidance subsystem of FIG. 3B showing bales thereon;

FIG. 5 is a top view of the guidance subsystem of FIGS. 3B and 4 showing a bale on a left intake conveyor urged toward an exit conveyor;

FIG. 6 is a top view of the guidance subsystem of FIG. 5 with the bale on the left intake conveyor moved further toward to the exit conveyor;

FIG. 7 is a top view of the guidance subsystem of FIG. 6 with the bale previously moved by the left intake conveyor completely moved onto the exit conveyor;

FIG. 8 is a top view of the exit chamber and the guidance subsystem of FIG. 3B in which the guidance subsystem is nonaligned with the exit chamber and in a first position;

FIG. 9 is a top view of the exit chamber and the guidance subsystem of FIG. 3B in which the guidance subsystem is nonaligned with the exit chamber and in a second position; and

FIG. 10 is a longitudinal section of an embodiment of an intake conveyor of the invention, drawn at a larger scale.

### DETAILED DESCRIPTION

The disclosure is directed at a multiple bale receiving system for a bale processor. In some embodiments, the disclosure includes a body portion for receiving multiple bales from a multiple-bale baler and then positions the bales to exit the body portion in a single file or line.

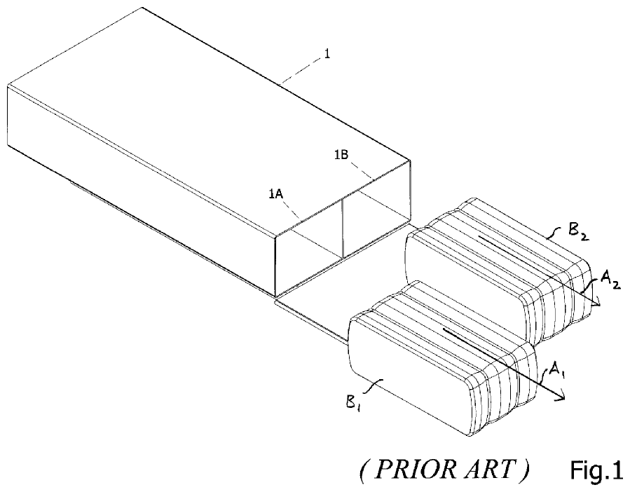

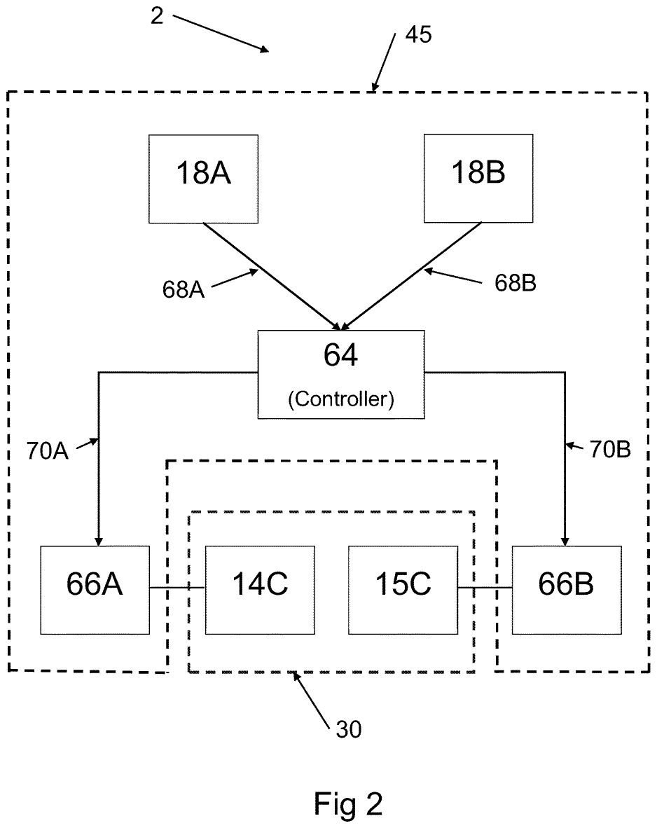

In the attached drawings, like reference numerals designate corresponding elements throughout. An embodiment of a multiple bale receiving system 2 of the disclosure is illustrated in FIGS. 2-10. As will be described, the multiple bale receiving system 2 is configured to be positioned upstream to a conventional bale processor (not shown), and downstream from the exit chamber of a baler such as, but not limited to the exit chamber 1 shown in FIG. 1.

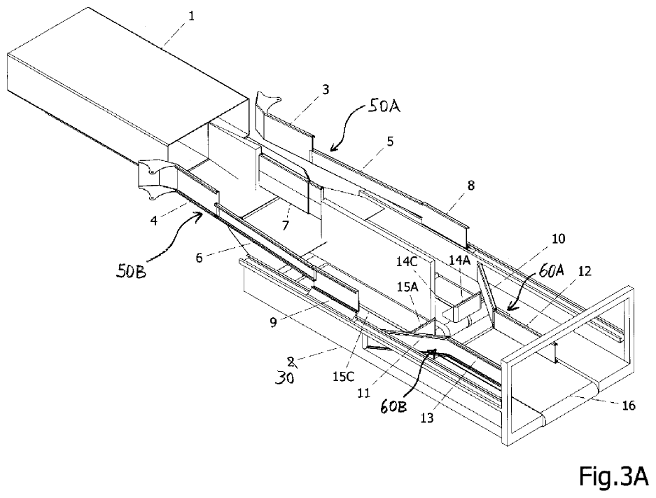

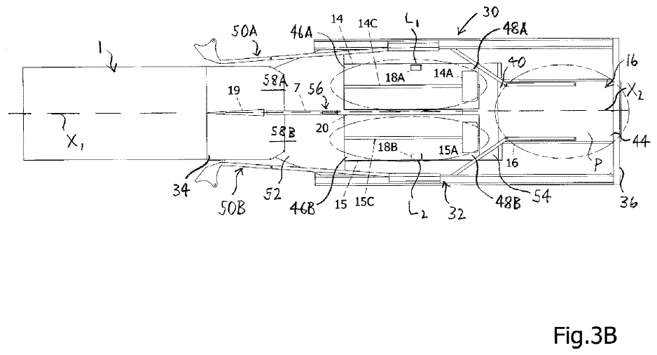

It will be understood that an exit chamber 1 is included in FIGS. 3A-7 and 10 solely for clarity of illustration and that the exit chamber 1 forms no part of the disclosure. The baler is otherwise omitted from the drawings, for clarity of illustration.

As schematically shown in FIG. 2, the system 2 includes a guidance subsystem 30 and a conveyor control subsystem 45. In the current embodiment, the guidance subsystem 30 includes a pair of drive chains 14C, 15C that are connected to motors 66A, 66B motors for the pair of drive chains or intake conveyors. In some embodiments, the guidance subsystem 30 may be mounted to the bale processor. In some embodiments, the drive chains may be belts or other propulsion devices.

The conveyor control subsystem 45 includes one or more sensors 18A, 18B that are connected to a controller 64 to transmit signals to the controller 64 such as in the direction of arrows 68A, 68B. In some embodiments, based on the signals received from the sensors and processed by the controller 64, the controller 64 transmits control signals to the motors 66A, 66B as schematically represented by arrows 70A, 70B. This will be described in more detail below.

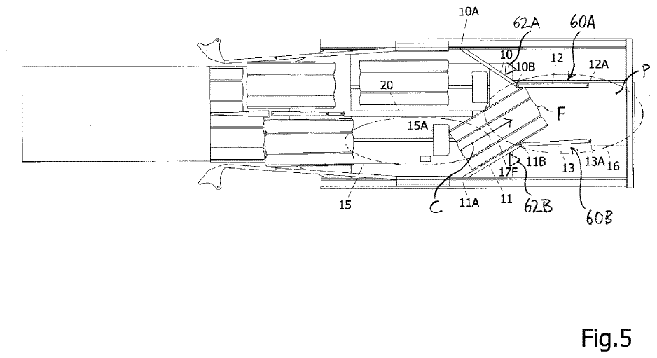

The system 2 is for collecting multiple bales from the exit chamber and individually guiding the bales to move along a path “P” (FIGS. 3B, 5). In one embodiment, the guidance subsystem 30 has a body 32 extending between an upstream end 34, at which the multiple bales enter the body 32, and a downstream end 36, at which the bales exit the body 32 in a single line. As can be seen in FIGS. 3A-7, the guidance subsystem 30 is positioned downstream from the exit chamber 1 of the baler. Within the guidance system is a guiding mechanism for directing bales from the upstream end 34 towards the downstream end 36.

The guidance subsystem 30 also includes an exit conveyor 16 mounted to the body 32. The exit conveyor 16 extends between an upstream end 40 that is located at an intermediate location within the body 32 and a downstream end 44 located proximal to the downstream end 36 of the body 32 (FIG. 3B). The intermediate location is between the upstream and downstream ends 34, 36 of the body 32. As will be described, the path “P” is defined by the exit conveyor 16 (FIG. 3B).

The guidance subsystem 30 also includes a pair of intake conveyors 14, 15, for receiving and moving the bales in a downstream direction toward the exit conveyor 16.

The exit chamber 1 defines a central axis “X₁” thereof, and the guidance subsystem 30 defines another central axis “X₂” thereof (FIG. 3B). In FIGS. 3A-7, the guidance subsystem 30 is shown with its central axis “X₂” aligned with the central axis “X₁” of the exit chamber 1. However, in other embodiments, the guidance subsystem 30 is movable relative to the exit chamber 1, so that the axes “X₁”, “X₂” may be non-aligned, when in use. For instance, when moving across a field following a generally straight path, the guidance subsystem 30 will be somewhat nonaligned with the exit chamber 1 from time to time. In some embodiments, the central axes “X₁” and “X₂” may still be parallel with respect to each other but not in the same linear path.

Based on signals received from the sensors 18A, 18B (in accordance with predetermined criteria), the conveyor control subsystem 45 (FIG. 2) selects a first one of the pair of intake conveyors 14, 15 for activation to move a selected bale thereon, and selects the second one of the pair of intake conveyors for de-activation based on the predetermined criteria. In one embodiment, the one or more sensors 18A, 18B determine or sense whether a bale is present at one or more predetermined locations on the respective intake conveyors 14, 15.

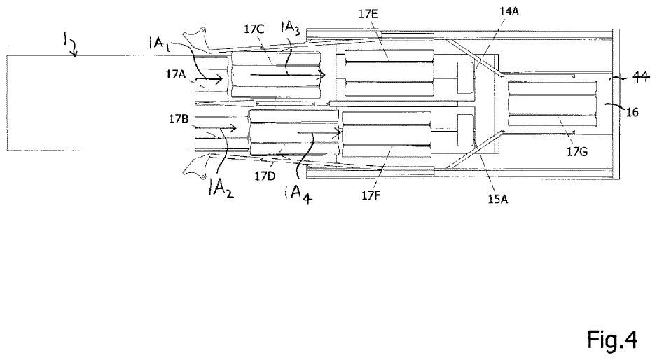

Upon activation, the first selected one of the pair of intake conveyors 14, 15 moves the selected bale downstream to position the selected bale on the upstream end 40 of the exit conveyor 16 so that the exit conveyor may move the selected bale to the downstream end 44 thereof (FIGS. 4-7). It will be understood that the bale processor (not shown) is positioned to receive each of the bales moved along the path “P” to the downstream end 44 of the exit conveyor 16. For example, the bale processor may have an intake chute (not shown) that is positioned immediately adjacent to the downstream end 44, to receive each bale in series in the intake chute.

In the embodiment illustrated, the system 2 is configured for receiving two rows of bales side by side from the baler via the bale chamber exits 1A and 1B, and moving one bale at a time via the intake conveyors 14, 15 to or through the exit conveyor 16.

As can be seen in FIG. 3B, the intake conveyors 14, 15 extend between their respective upstream ends 46A, 46B and downstream ends 48A, 48B.

In the embodiment illustrated, the exit conveyor 16 is a belt conveyor and the exposed surface of the belt defines the path “P”. It will be understood that the exit conveyor 16 is sized for moving one bale at a time, consistent with the intake chute of the bale processor. Those skilled in the art would appreciate that the exit conveyor may have any suitable configuration.

The intake conveyors 14, 15 may have any suitable configuration. As an example, in the embodiment illustrated in FIGS. 3A-7 and 10, the left and right entry conveyors 14, 15 include one or more paddles, mounted to respective drive chains 14C, 15C for pushing the bale from the upstream ends 46A, 46B of the intake conveyors 14, 15 to the downstream end of the intake conveyors 14, 15 proximate to the upstream end of the exit conveyor 16.

In some embodiments, the intake conveyors may be a belt or other form of conveyor, or a linear pushing device such as, but not limited to, a cylinder, or any other suitable means of conveyance.

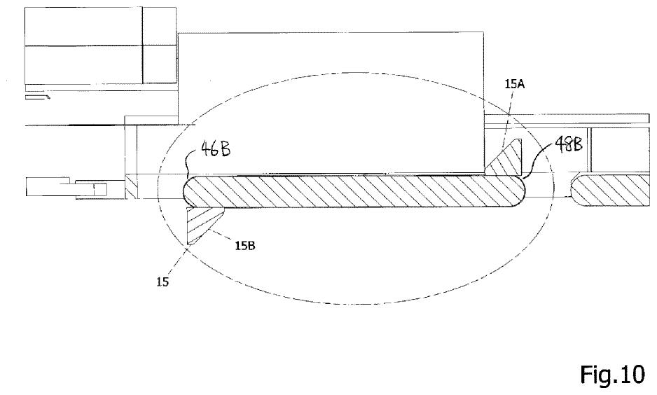

In one embodiment, the intake conveyors 14, 15 include the respective drive chains 14C, 15C. As can be seen in FIGS. 3B and 10, the intake conveyors may include at least one paddle mounted to the drive chain. For clarity of illustration, only one paddle 14A, 15A for each of the intake conveyors 14, 15 is shown in FIGS. 3A-4, 6, and 7. As can be seen in FIG. 10, the intake conveyor 15 may include two paddles 15A, 15B. It will be understood that the other conveyor 14 may also have a second paddle, however, only one paddle of the intake conveyor 14 is shown for clarity of illustration.

In the present embodiment, the conveyor paddles stop at the downstream ends 48A, 48B of the conveyors 14, 15 while waiting for the next bale. Alternatively, however, the conveyor paddles could stop at any other position.

In one embodiment, the guidance subsystem 30 includes left and right entry guide assemblies 50B, 50A that are configured to guide the bales entering the guidance subsystem 30 at the upstream end 34 of the body 32 to the respective upstream ends 46A, 46B of the intake conveyors 14, 15 (FIG. 3B). In the example illustrated, the left entry guide panel assembly 50B includes first, second, and third panels 4, 6, 9 (FIG. 3A) and the right entry guide panel assembly 50A includes first, second, and third panels 3, 5 and 8 (FIG. 3A). In some embodiments, the first, second and third panels of the left entry guide panel assembly or the right entry guide panel assembly may be formed by rails or belts and the like rather than panels, such as metal panels. The left entry guide panel assembly and the right entry guide panel assembly may form part of the guiding mechanism. In other embodiments, the guiding mechanism may be implemented via a set of hydraulics and corresponding sensors.

The first panels 3, 4 are pivotable at the exit chamber 1 of the baler although in other embodiments, the first panels 3, 4 may be stationary with respect to the exit chamber. In one embodiment, the first panels 3, 4 may be pivotably connected to the exit chamber 1 at respective upstream ends thereof. The entry guide panel assemblies 50A, 50B are partially slidingly mounted to the body 32.

As can be seen in FIG. 3B, the body 32 includes an upstream floor portion 52 extending between the upstream end 34 of the body 32 and the respective upstream ends 46A, 46B of the intake conveyors 14, 15. The body 32 may also include a downstream floor portion 54 that extends between the downstream ends 48A, 48B of the intake conveyors 14, 15 and the upstream end 40 of the exit conveyor 16.

As can also be seen in FIG. 3B, the guidance subsystem 30 includes a central guide panel assembly 56 mounted to the body 32. The central guide panel assembly 56, partially defines respective intake paths 58A, 58B from the upstream end 34 of the body 32 to the upstream ends 46A, 46B of the intake conveyors 14, 15. The central guide panel assembly 56 also is at least partially positioned between the intake conveyors 14, 15 (FIG. 3B).

The central guide panel assembly 56 includes first, second, and third central guide panels 19, 7 and 20 (FIG. 3B).

As can be seen in FIGS. 3A and 5, the guidance subsystem 30 includes right and left exit guide panel assemblies 60A, 60B. The exit guide panel assemblies 60A, 60B are configured for guiding the bales from the downstream ends 48A, 48B of the intake conveyors 14, 15 to the upstream end 40 of the exit conveyor 16. In the current embodiment, the left exit guide panel assembly 60A includes panels 10, 12 while the right exit guide panel assembly 60B includes panels 11, 13 (FIG. 5).

In one embodiment, the exit guide panel assemblies 60A, 60B also include respective actuators (62A, 62B) configured for moving selected panels thereof generally or partially laterally, to allow the bales to move through the body 32 to the exit conveyor (FIG. 5). The actuators 62A, 62B may be any suitable device configured for urging or moving one or more of the selected panels when activated, for guiding the bales to the upstream end 40 of the exit conveyor 16 with minimal or little engagement with the selected panels and/or with the third central panel 20. It will be understood that the actuators 62A, 62B are schematically illustrated in FIG. 5 for clarity of illustration.

In some embodiments, the conveyor control subsystem 45 may include any suitable number of sensors. In the embodiment illustrated, the conveyor control subsystem 45 includes only two sensors 18A, 18B. As can be seen in FIG. 3B, the sensors 18A, 18B are located proximal to the respective intake conveyors 14, 15, approximately equidistant from the upstream and downstream ends thereof. The predetermined locations of the sensors 18A, 18B are identified by reference characters “L₁”, “L₂” in FIG. 3B respectively. The sensors 18A, 18B may be any suitable device for detecting the presence of a bale. Those skilled in the art would be aware of suitable sensors.

For instance, each of the sensors 18A, 18B may be a switch activatable by moving a lever (not shown) thereon. In this example, when the bale engages the lever at the predetermined location, the switch then transmits an input signal to a controller 64 (FIG. 2). The signal indicates that the bale arrived at the location where the switch is positioned, and the time when the bale arrived. The signal may simply indicate the presence of a bale.

In one embodiment, once the input signal is received by the controller 64, the controller 64 may activate a motor that drives the relevant intake conveyor (associated with the received signal), which is proximal to the sensor on which the bale is located. In FIG. 2, the motors of the intake conveyors 14, 15 are respectively identified by reference characters 66A, 66B. The motors 66A, 66B may be any suitable motors.

The controller 64 is configured to process the input signals generated by the sensors 18A, 18B. For example, if signals are generated by both of the sensors 18A, 18B at approximately the same time, then the intake conveyor proximal to the sensor that sent the earlier signal is activated.

If signals from both sensors 18A, 18B are received by the controller at the same time, or at virtually the same time, then the controller 64 is configured to select a predetermined intake conveyor for activation. For instance, the controller 64 may be configured to select the intake conveyor 14 if bales arrive at the locations “L₁”, “L₂” at virtually the same time.

As noted above, then the controller 64 selects one of the intake conveyors 14, 15 for activation, the other (unselected) conveyor is not activated. Those skilled in the art would appreciate that only one conveyor should be activated for a discrete time period, because activating the conveyors without allowing for a delay between activations thereof might result in bales jamming or crashing together downstream from the intake conveyors or at the entrance of the exit conveyor. In other embodiments, the intake conveyors may continue to operate or roll but the system includes stops whereby bales are the positioned atop the intake conveyors stop travelling due to the stop while the intake conveyor continues to roll.

In one embodiment, the intake conveyor motors 66A, 66B are both configured to be constrained by respective relief devices (not shown). The relief devices may be set up or implemented to stop the motors 66A, 66B (i.e., via the controller 64) if the motors 66A, 66B encounter unusual resistance (i.e., above a predetermined limit threshold). If a bale that is moved by an intake conveyor becomes jammed, e.g., at or near the upstream end 40 of the exit conveyor 16, then the motor of that intake conveyor encounters resistance greater than the predetermined limit threshold. At that point, the relief device causes the intake conveyor to be de-activated.

When one of the intake conveyors is de-activated by a relief device, a suitable signal is sent to an operator (not shown) or an audible alarm may be initiated. It is also preferred that, where one of the intake conveyors is de-activated due to a jam, the other intake conveyor is also not activatable although the other intake conveyor may continue to operate.

In some embodiments, the controller 64 may be located in any convenient location, e.g., in or on the guidance subsystem 30 or inside a cab (not shown) on a tractor. The input signals from the sensors 18A, 18B may be transmitted to the controller 64 via any suitable means, e.g., wirelessly or otherwise. The transmitted input signals are schematically represented in FIG. 2 by arrows 68A, 68B.

As noted above, the controller 64 processes signals received from the sensors 18A, 18B and generates command signals that are transmitted to the motors 66A, 66B. The command signals may be transmitted wirelessly or otherwise.

As noted above, upon a motor receiving a command signal for activation thereof, the motor is energized, and moves the drive chain to which it is connected.

In one embodiment, the exit conveyor 16 includes a separate motor thereof (not shown). The exit conveyor 16 may be activated while the system 2 is operating, except that the exit conveyor 16 is de-activated when one of the intake conveyors is de-activated because a predetermined limit threshold has been exceeded.

FIGS. 3B and 4 illustrate how the bales move through the guidance subsystem 30. The bales 17A, 17B are shown exiting the exit chamber 1, urged in the directions indicated by arrows “1A₁”, “1A₂”. Those skilled in the art would appreciate that the bales 17A, 17B are urged out of the exit chamber 1 by other bales (not shown) that are upstream, relative to the bales 17A, 17B.

In one embodiment, the guidance subsystem 30 may include one or more actuators (not shown) for moving one or more of the panels of the intake guide panel assemblies 50A, 50B so that the intake guide panels guide the bales along the intake paths 58A, 58B with minimal or little engagement with the intake guide panels and/or with the central guide panels 19, 7, 20.

Bales 17C, 17D are immediately downstream from and pushed by the bales 17A, 17B. The bales 17C, 17D are urged in the directions indicated by arrows “1A₃”, “1A₄” by the bales that are upstream thereto.

The bales 17E, 17F have been urged by the bales upstream to them until the bales 17E, 17F are at least partially on the respective intake conveyors 14, 15, at the upstream ends 46A, 46B.

in FIG. 4, a bale 17G is shown positioned on the path “P”.

As noted above, when the bales 17E, 17F are moved onto the intake conveyors 14, 15, their positions are sensed by the respective sensors 18A, 18B. Based on the signals transmitted by the sensors 18A, 18B to the controller 64 (FIG. 2), the controller 64 activates one of the conveyors 14, 15.

In the example illustrated in FIG. 5, the controller 64 has activated the intake conveyor 15, causing the bale 17F to move in the direction indicated by arrow “C” in FIG. 4. As can be seen in FIG. 5, the bale 17F engages the exit guide panel 11, causing its front end “F” to be located or positioned on the upstream end 40 of the exit conveyor 16.

When the intake conveyor 15 is activated, the motor 66B thereof is energized, moving the chain 15C, to move the paddle 15A toward the downstream end 48B of the intake conveyor 15. In the example illustrated, the paddle 15A engages the bale 17F and pushes the bale 17F to the downstream end 48B and toward the upstream end 40 of the exit conveyor 16 (FIG. 5).

As the bale is moved onto the exit conveyor 16, the exit guide panel assemblies 60A, 60B guide the bale to align it with the path “P” (FIGS. 5-7).

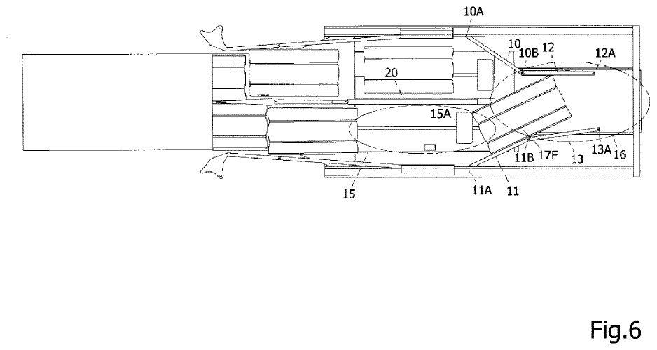

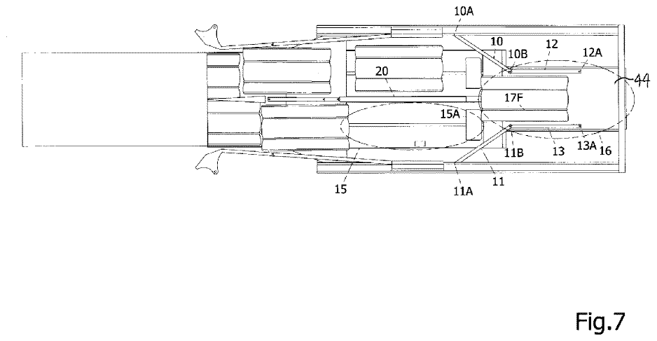

Once the bale 17F is located on the exit conveyor 16 at the upstream end 40 thereof (FIGS. 5, 6), the exit conveyor 16 can move the bale to the downstream end 44 thereof (FIG. 7). It will be understood that the bale processor (not shown) is positioned adjacent to the downstream end 44 of the exit conveyor 16. For instance, the bale processor may be positioned so that the bale that is moved by the exit conveyor may fall off the exit conveyor 16 at the downstream end 44 onto an intake chute or intake conveyor (not shown) of the bale processor.

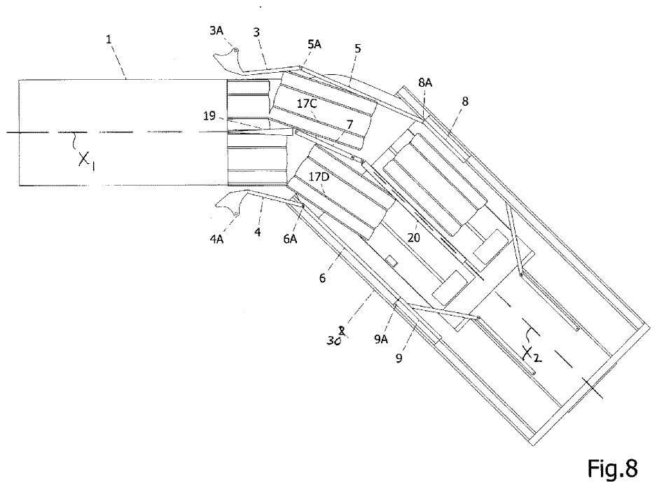

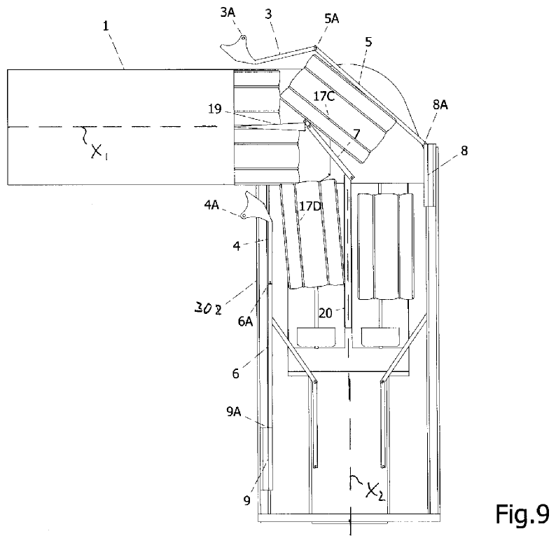

In FIGS. 8 and 9, it can be seen that the guidance subsystem 30 is continuously positioned to receive the bales from the baler, via the exit chamber 1, as the baler turns. In the examples illustrated in FIGS. 8 and 9, the baler has turned to the left relative to the guidance subsystem 30, so that the axes “X₁”, “X₂” are nonaligned. The positions of the exit chamber 1 and the guidance subsystem 30 that are illustrated in FIGS. 8 and 9 are examples of the way in which the exit chamber 1 and the guidance subsystem 30 may be out of alignment, for instance, when the baler is required to turn at the end of a row. The entry guide panel assemblies 50A, 50B are configured to guide the bales notwithstanding the nonalignment.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

I claim:

1. A system for collecting multiple bales and guiding the multiple bales separately to move individually along a path, the system comprising:
a guidance subsystem comprising:
a body extending between an upstream end, at which the multiple bales enter the body, and a downstream end, at which the bales exit the body individually;
an exit conveyor mounted to the body and extending between an upstream end thereof at an intermediate point on the body and a downstream end thereof located proximal to the downstream end of the body;
a set of intake conveyors, for moving the bales in a downstream direction toward the upstream end of the exit conveyor; and
a conveyor control subsystem, for selecting a first one of the set of intake conveyors for activation to move a selected bale thereon, and selecting a second one of the pair of intake conveyors for de-activation based on predetermined criteria,
wherein upon activation, the first selected one of the pair of intake conveyors moves the selected bale downstream to position the selected bale on the upstream end of the exit conveyor, for the exit conveyor to move the selected bale to the downstream end thereof.

2. A system for collecting and guiding bales to a bale processor comprising:
a guidance subsystem including:
a body portion;
an intake conveyor portion connected to one end of the body, the intake conveyor portion including at least two intake conveyors; and
an exit conveyor portion connected located between the body portion and the bale processor;
a conveyor control subsystem for activating one of the at least two intake conveyors in response to a signal indicating a presence of a bale within the one of the at least two intake conveyors and for deactivating each of the other of the at least two intake conveyors;
wherein activation of the one of the at least two conveyors urges the bale from the intake conveyor to the exit conveyor portion to move the bale in a single file to the bale processor.

3. The system of claim 2 wherein the conveyor control subsystem comprises:
a set of sensors associated with each of the at least two intake conveyors to sense a presence of a bale within its associated intake conveyor.

4. The system of claim 3 further comprising a processor for receiving a bale sensing signal from one of the set of sensors and activating the intake conveyor associated with the sensor transmitting the bale sensing signals and for deactivating each of the other intake conveyors.

5. The system of claim 3 wherein each of the intake conveyors comprises a set of paddles for directing received bales towards the exit conveyor.

6. The system of claim 2 wherein the guidance subsystem further comprises a guiding mechanism located between the intake conveyor portion and the exit conveyor portion to guide the bales from the intake conveyor portion to the exit conveyor.

7. The system of claim 6 wherein the guiding mechanism comprises a set of entry guide panel assemblies.

8. The system of claim 7 wherein each of the set of entry guide panel assemblies comprises a set of guide panels.

9. The system of claim 6 wherein the guiding mechanism comprises a central guide panel assembly.

10. The system of claim 1 wherein the exit conveyor portion is a belt conveyor.
